(19) United States
(12) Patent Application Publication
(10) Pub. No.: US 2012/0313400 A1
(43) Pub. Date: Dec. 13, 2012

(54) VEHICLE PILLAR ASSEMBLY

(76) Inventors: Jason Scott Balzer, Commerce Township, MI (US); Ryan Craig, Harrison Township, MI (US)

(21) Appl. No.: 13/158,647

(22) Filed: Jun. 13, 2011

(51) Int. Cl. B62D 25/04

(52) U.S. Cl. 296/193.06

(57) ABSTRACT

A vehicle pillar assembly is provided which includes a roof rail, a rocker, a first hollow support member, and a second hollow support member. The first hollow support member and the second hollow support member each includes a first wall, a second wall, a third wall and optionally a fourth wall. The first hollow support member and the second hollow support member each include a tubular lower area that extends upwardly from the rocker panel. The tubular lower area includes at least one crush initiator. The first hollow support member and the second hollow support member also each include an upper section that extends downwardly from the roof rail.

### BACKGROUND

The present disclosure relates generally to vehicle structures, and more particularly to a roof support assembly and side impact structure for a vehicle.

Vehicle pillars support the roof of a vehicle and are located between the windows and doors of a vehicle. Vehicle pillars are frequently identified as A, B, C and in some instances D-Pillars depending on the vehicle style. A B-Pillar is generally located immediately behind the front door of a vehicle and is traditionally used to mount the rear door hinges and associated rear doors. The B-Pillar is an important element in determining roof strength and the degree of side impact intrusion.

The vehicle pillars for a vehicle may be manufactured using a tubular hydroforming process which is a metal-forming process in which a fluid is used to outwardly expand a tubular metal blank into conformity with surfaces of a die assembly cavity to form an individual hydroformed member. A tubular blank can be shaped during the hydroforming process to have a cross-section that varies continuously along its length. Tubular hydroforming enables manufacturers to increase part stiffness, dimensional accuracy, fatigue life, and crashworthiness over non-hydroformed parts (such as stamped parts for example) while reducing part mass and cost.

Hydroformed components have high strength relative to their mass (as compared to stamped sheet metal components for example), in part because of the plastic deformation in the wall of the blank which occurs during the hydroforming process. The outward expansion of the tubular metallic wall of the blank during hydroforming caused by the fluid pressure within the blank creates a work-hardening effect which uniformly hardens the metallic material of the resulting hydroformed member. Hydroforming also produces less waste material than stamping. Hydroformed parts are relatively economical for vehicle manufacturers to produce because the tooling costs associated with hydroforming are typically lower than those associated with other manufacturing methods.

Passenger vehicle designs are tested for roof strength and side impact strength. Conventional B-Pillars are fabricated as multiple stamped sheet metal parts that are generally spot welded together. It is possible to improve the strength of conventional B-Pillars by forming the sheet metal parts from high grade material, such as dual phase and boron steels. B-Pillars may also be made stronger by using thicker gauge alloys and thicker sheet metal may increase the weight of a vehicle and also increase the cost to manufacture the B-Pillar. Even with the use of thicker alloy components, B-Pillars of conventional design may not always meet stringent test requirements for roof strength and side impact performance.

It has been proposed to use hydroformed tubes to fabricate vehicles having space frame construction in, for example, U.S. Pat. No. 6,282,790. This patent proposes integrally forming two B-Pillars and a roof bow in a single U-shaped piece that is connected to the top surface of two tubular rockers. However, this design is inefficient in that it implements the same material thickness throughout the length of the tube. Furthermore, this structure does not provide the desired side impact performance wherein energy absorption is controlled to lower the buckle point of the vehicle pillar.

### SUMMARY

A vehicle pillar assembly is provided according to the embodiment(s) disclosed herein. The vehicle pillar assembly includes a roof rail, a rocker panel, a first hollow support member and a second hollow support member. The first hollow support member and the second hollow support member each includes a first wall, a second wall, a third wall, and optionally, a fourth wall. The first hollow support member and the second hollow support member each include a tubular lower area that extends upwardly from the rocker panel. The tubular lower area includes at least one crush initiator. The first hollow support member and the second hollow support member also each include an upper section that extends downwardly from the roof rail.

### BRIEF DESCRIPTION OF THE DRAWINGS

The present invention will now be described by way of example, with reference to the accompanying drawings:

FIG. 1 is a perspective view of a vehicle pillar structure of the present disclosure.

FIG. 2A is a perspective view of an embodiment of the present disclosure having a crush initiator in the form of an aperture.

FIG. 2B is a cross section of an embodiment of the present disclosure along lines 2B-2B in FIG. 2A.

FIG. 2C is a cross section of an embodiment along lines 2C-2C in FIG. 2A.

FIG. 3A is a perspective view of an embodiment of the first and second hydroformed members of the present disclosure where the crush initiators are apertures.

FIG. 3B is a cross sectional view along lines 3B-3B in FIG. 3A.

FIG. 4A is a perspective exterior view of another embodiment of the present disclosure having a reinforcement where the crush initiator on the second hydroformed member is a bead.

FIG. 4B is a perspective interior view of the embodiment shown in FIG. 4A.

FIG. 4C is an expanded view of the pillar structure shown in FIG. 4A.

FIG. 5A is a cross section of an embodiment of the present disclosure along lines 5-5 in FIG. 4A.

FIG. 5B is a cross section of another embodiment of the present disclosure.

FIG. 5C is a cross section of yet another embodiment of the present disclosure.

FIG. 5D is a cross section of an embodiment of the present disclosure.

FIG. 6 is a cross section of yet another embodiment of the present disclosure.

### DETAILED DESCRIPTION

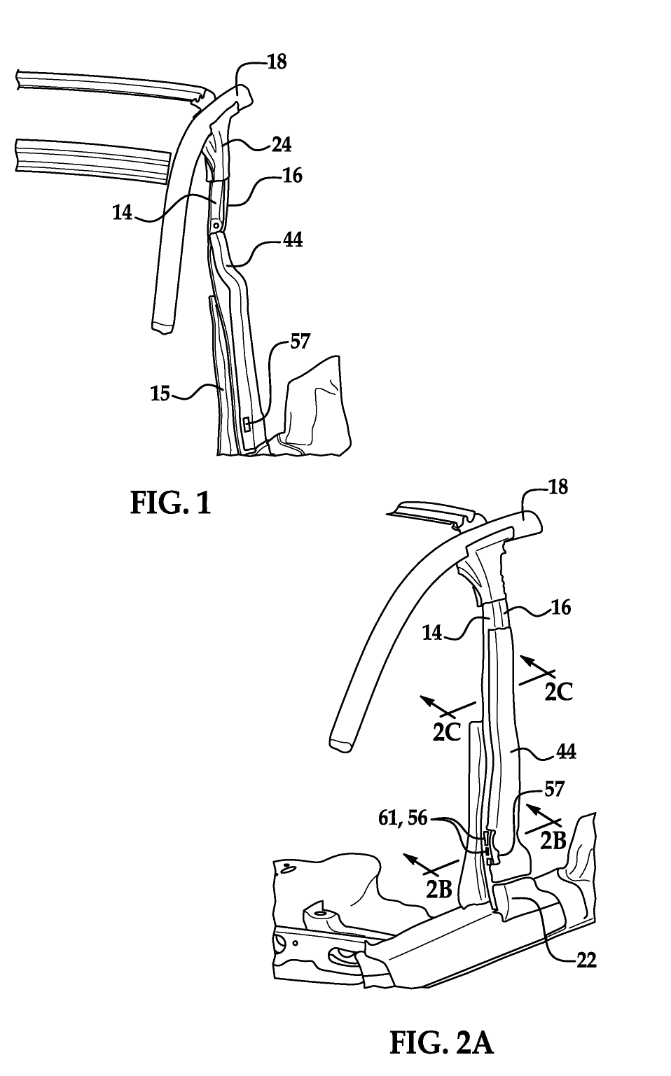

Referring now to the drawings wherein like reference numerals are used to identify identical components in the various views, FIG. 1 illustrates the first hollow support member 14 and the second hollow support member 16. The first hollow support member 14 and the second hollow support member 16 may be disposed within a body side inner panel (not shown in FIG. 1) wherein the body side inner panel (not shown) may be formed from stamped sheet metal. The first hollow support member 14 and the second hollow support member 16 may be formed into a desired configuration using a hydroforming process. In this non-limiting example, the ends of the first hollow support member 14 and the second hollow support member 16 terminate adjacent to the roof rail 18 and adjacent to the rocker 20.

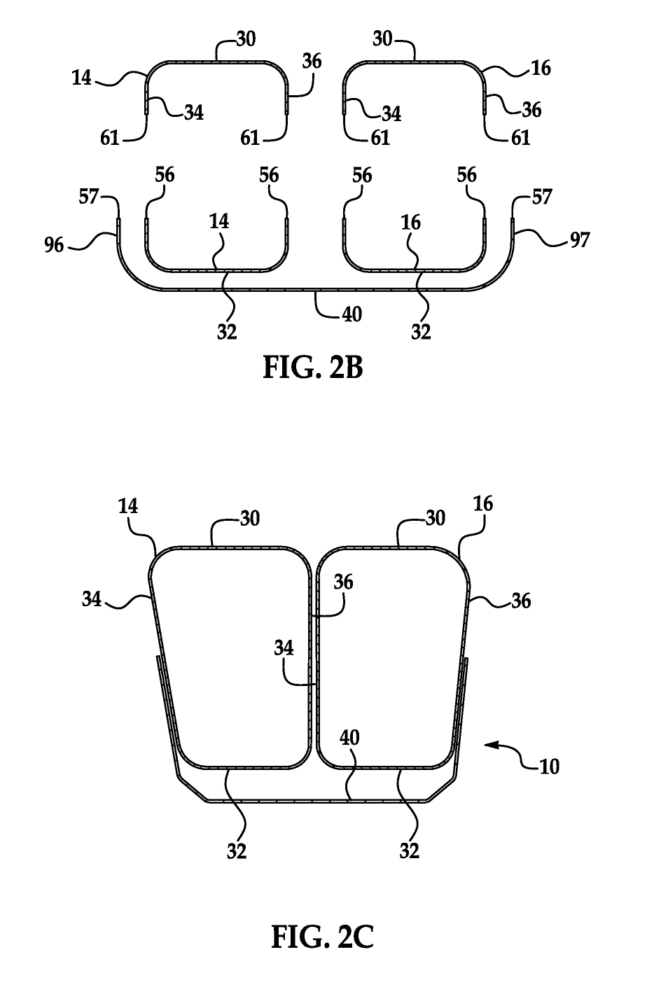

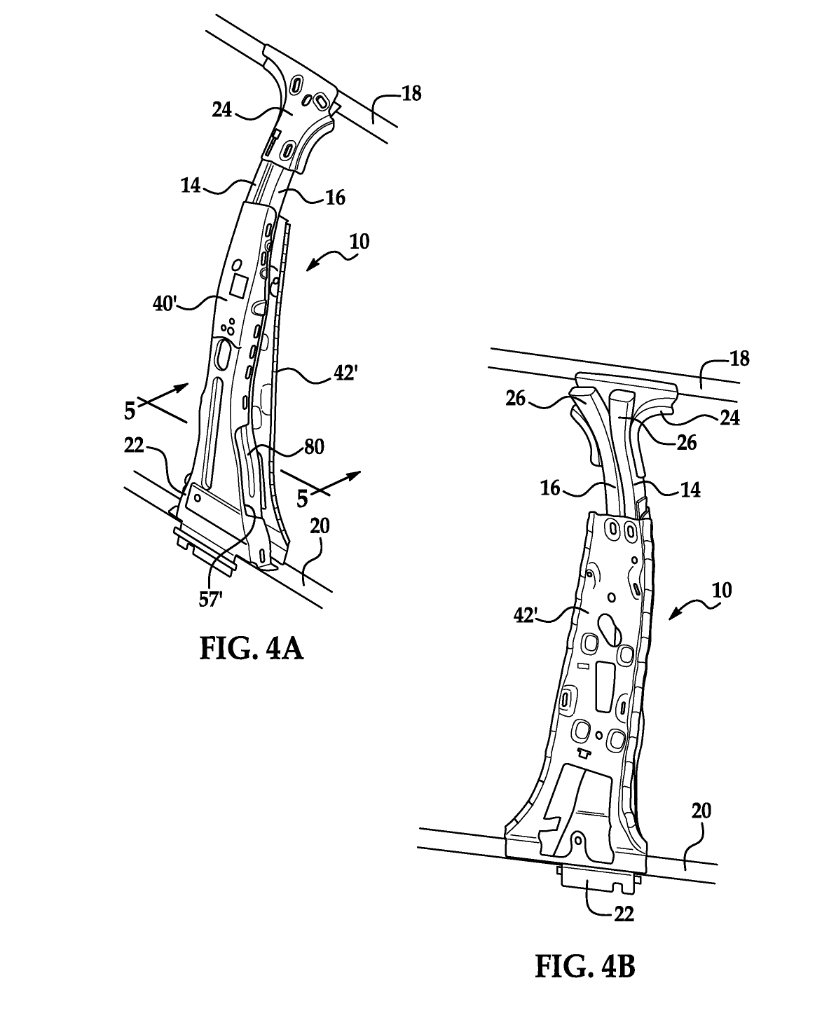

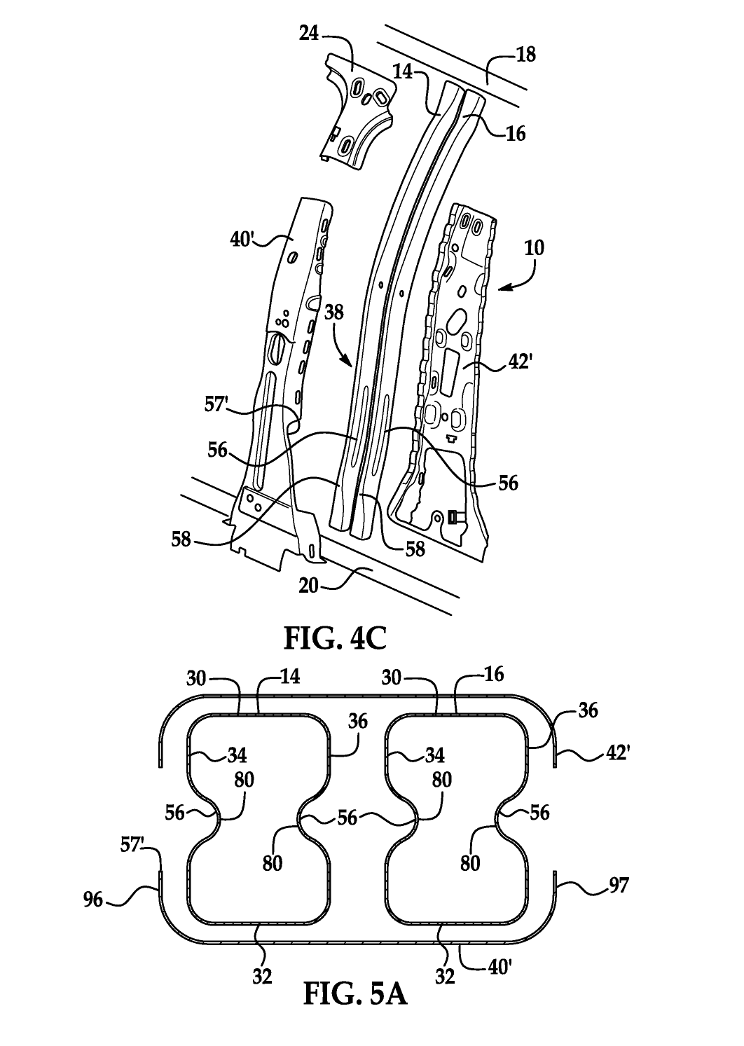

The first hollow support member and the second hollow support member may each include a lower tubular area 58 (shown in FIG. 4C) that extends upwardly from the rocker 20 (shown in FIG. 4C). Each lower tubular area includes at least one crush initiator. The crush initiator may come in various forms, including but not limited to an aperture 61 (shown in FIG. 2A) or a bead (shown in FIG. 4A). A side impact reinforcement member 44 may also be provided which includes a reinforcement crush initiator 57, or alternatively referred to as a crush initiator.

The first hollow support member 14 and the second hollow support member 16 may each be coupled to the rocker 20 and the roof rail 18 using a rocker reinforcement 22 (FIG. 2A) and a b-pillar outer bracket 24 (FIG. 1).

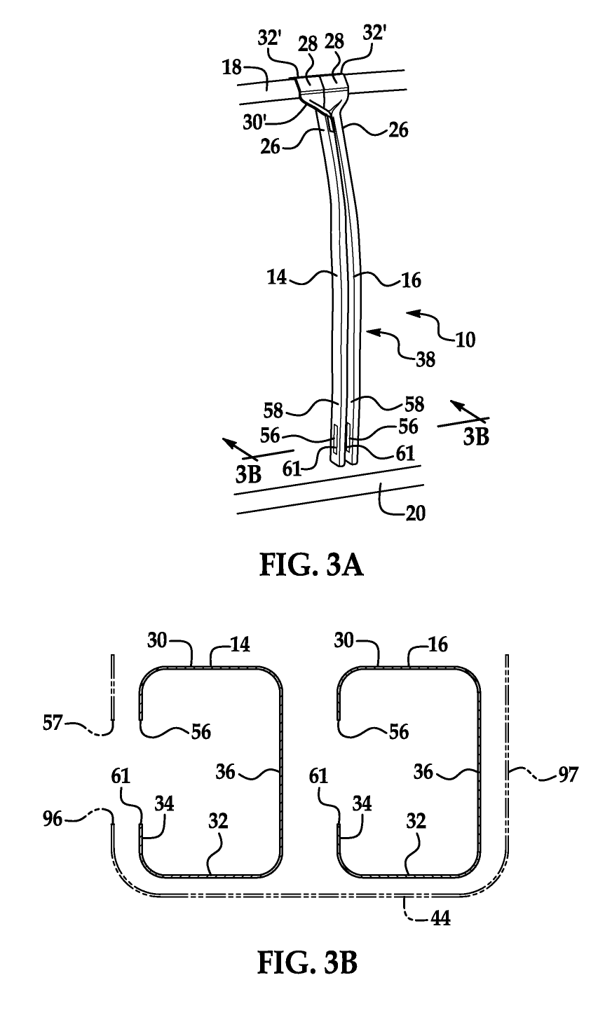

Referring now to the non-limiting example of FIG. 3A, the first and second hollow support members 14, 16 may each include an upper end 26 wherein the upper end 26 is proximate to the roof rail 18. The upper end 26 of each of the first hollow support member 14 and the second hollow support member 16 may be compressed together to form a rail attachment flange 28. The rail attachment flange 28 may then be assembled to an outer surface and an upper surface of the roof rail 18 via a spot welding process or the like. The rail attachment flange 28 includes only an inner wall (not shown) and an outer wall 32′.

Referring now to FIG. 2A, the side impact reinforcement member 44 may include at least one reinforcement crush initiator 57. A non-limiting example of a reinforcement crush initiator 57 is shown in FIG. 2A as an opening or recess. Crush initiators 56 may also be provided in the first and second hollow support members 14, 16 in the form of an aperture 61, as one non-limiting example. The apertures 61 in the first and second hollow support members 14, 16 may be elongated (rectangular or oval) or may be circular in shape. Furthermore, multiple apertures 61 may be used in lieu of a single large aperture 61. As shown in the non-limiting examples of FIGS. 2B and 3B, the apertures 61 may be formed in the front wall 34 and/or the rear wall 36 of each of the first hollow support member 14 and the second hollow support member 16. It is to be understood that a bead 80 (shown in FIG. 4A), may also be implemented as yet another non-limiting example of a crush initiator 56.

As shown in FIGS. 2A and 2B, a vehicle pillar assembly 10 of the present disclosure may include a roof rail 18, a rocker 20 (shown in FIGS. 4A and 4B), a first hollow support member 14 and a second hollow support member 16. In this non-limiting example, the first hollow support member 14 and the second hollow support member 16 may each include four walls wherein apertures 61 may be defined in the front and rear walls 34, 36 of each of the first and second hollow support members 14, 16. An opening or recess may also be defined in the side impact reinforcement member 44 as the reinforcement crush initiator 57 shown in FIGS. 2A and 2B.

The side impact reinforcement 40 is disposed across the first and second hollow support members 14, 16 and may be affixed to the front wall 34 of the first hydroformed support member 14 and to the rear wall 36 of the second hydroformed support member 16. The side impact reinforcement member 40 and the first and second hydroformed support members 14, 16 may be disposed within a recess of the body side panel (not shown).

The joining structure of the first and second hollow support members to the rocker 20 may be provided in the form of a rocker reinforcement 22 (FIG. 2A). As such, the tubular lower area 56 may terminate adjacent to the rocker 20 and the rocker reinforcement 22 may couple the first and second hollow support members 14, 16 to the rocker 20. The rocker reinforcement 22 may be affixed to the rocker 20 and the first and second hollow support members 14, 16 via a welding process or mechanical fasteners or the like.

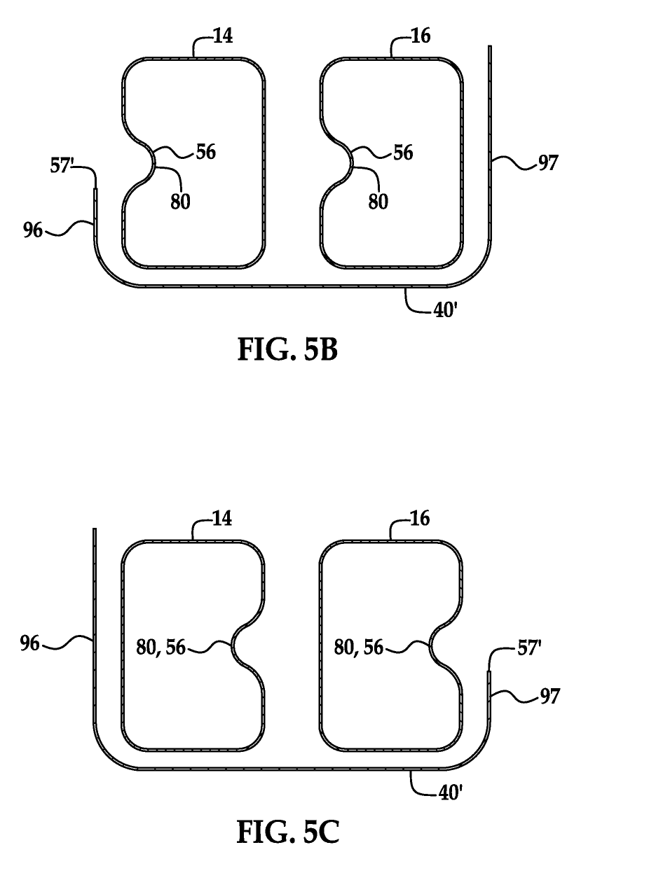

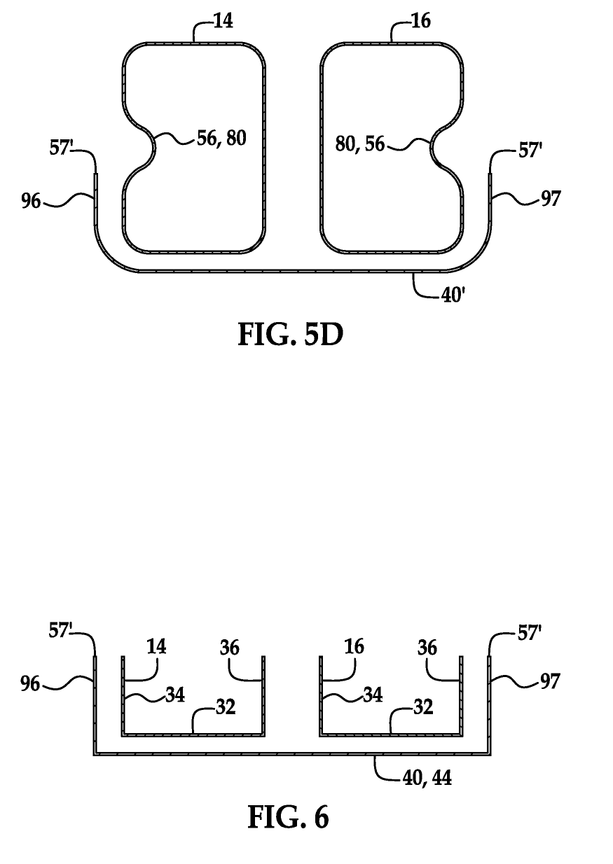

In FIGS. 3A and 3B, the apertures 61 (or beads 80 shown in FIG. 5B) may be defined in only the front walls 34 of the first and second hollow support members 14, 16. It is also to be understood that the apertures 61 or beads 80 also may be defined in only the rear walls 36 of the first and/or second hollow support members 14, 16 as well, in yet another non-limiting example.

In the embodiment shown in FIG. 3A, the first and second hollow support members 14, 16 may each include an upper end 26 wherein the upper end 26 is proximate to the roof rail 18. One alternative to being coupled to the roof rail 18 via the B-Pillar outer bracket 24 (shown in FIGS. 5A-5C), the upper end 26 of each of the first hollow support member and the second hollow support member may be compressed together to form a rail attachment flange 28 (FIG. 3). The rail attachment flange 28 may then be assembled to an outer surface and an upper surface of the roof rail 18 via a spot welding process or the like. The rail attachment flange 28 includes an inner wall (not shown) and an outer wall 32′.

Referring now to the non-limiting example of FIGS. 4A-4C and 5A, an inner wall 30, an outer wall 32, a front wall 34, and a rear wall 36 are provided for each of the first and second hollow support members 14, 16. The first hollow support member 14 and the second hollow support member 16 may define at least one crush initiator 56 in the form of a bead 80 on the front and/or rear walls 34, 36 of the first hollow support member 14 and the second hollow support member 16. It is to be understood that a bead 80 is a depression that may be formed along a portion of the length of the first hollow support member 14 and/or the second hollow support member 16.

In this non-limiting example of where the first hollow support member 14 and the second hollow support member 16 are hydroformed tubes, the shape of the bead 80 is defined in the tooling (mold) that houses the pre-hydroformed tube. When high pressure fluid fills the tube, the bead 80 of the hydroformed tube is formed as the material of the first and second hollow support members is pushed against tooling (mold). Both the bead 80 and the aperture 82 (shown in FIGS. 3A-3C) are therefore operatively configured to function as crush initiators 56.

As indicated in one non-limiting example, a crush initiator 56 may be provided in the form of an open section such as the non-limiting example shown in FIG. 6 wherein an inner wall 30 (shown in FIG. 2C) is not provided in the lower portion 58 (shown in FIG. 3A) of the first and/or second hollow support members 14, 16.

Regardless of the form of the crush initiator 56, the present disclosure provides increased strength in specific areas such as the upper portion 26 and the middle portion 38 of the vehicle pillar 10 relative to the lower portion 58 of the vehicle pillar 70 (where the crush initiators 56 are located). This solution therefore allows for controlled energy absorption at the lower portion 58 of the vehicle pillar 10. Accordingly, the side impact performance of the vehicle body structure is enhanced when energy absorption occurs at the lower portion 58 of the vehicle pillar 10, thereby allowing the loads to be supported at the rocker 20 (shown in FIG. 2A).

With reference to FIG. 2C, by having two inner walls 30, two outer walls 32, two front walls 34 and two rear walls 34, the first hollow support member 14 and the second hollow support member 16 provide added roof support strength in the upper portion 26. Given their aforementioned configuration, the first hollow support member 14 and the second hollow support member 16 are more resistant to bending at the upper portion 26 of the vehicle pillar 10. Furthermore, the material gauge for the first and second hollow support members 14, 16 may be reduced relative to traditional tubular support members thereby reducing weight and cost. In one non-limiting example, the first and second hydroformed support members 14, 16 may be formed from 1.66 mm DP780 steel.

With reference to FIGS. 2A and 4A, the vehicle pillar assembly 10 may also optionally include a side-impact reinforcement 40, 44 which is disposed along the middle area 38 of the first and second hollow support members 14, 16. Given that the first and second hollow support members 14, 16 may generally have the same gauge thickness throughout, the addition of a side-impact reinforcement 40, 44 provides additional strength and stiffness where such side-impact reinforcement 40, 44 is needed in the middle area 38 of the first and second hollow support members 14, 16 in the event of a side impact event. In conjunction with the crush initiators 56 in the lower tubular area, the side-impact reinforcement 40, 44 may provide the desired performance in a side impact event given that the side-impact reinforcement 40, 44 further strengthens the middle portion 38 of the vehicle pillar 10. The side impact reinforcement 40, 44 may further define at least one crush initiator 56 proximate to the lower portion 58 of the side-impact reinforcement 40, 44 to encourage energy absorption in the lower portion 58 of the vehicle pillar 10.

As shown in FIG. 3B, the side impact reinforcement 44 may also define apertures 57 on the front reinforcement wall 96 in order to provide enhanced side impact performance by lowering the buckle line of the vehicle toward the rocker in the event of a side-impact. It is to be understood that the rear reinforcement wall 97 may also define at least one aperture to provide enhanced side impact performance as well.

As shown in FIG. 4A, side impact reinforcement 40 incorporates a rocker reinforcement 24 such that the side impact reinforcement 40 extends all the way down to the rocker 20. In this example, the side impact reinforcement 40 may also include a crush initiator 56 shown as a recess 67 in FIG. 4A. It may also be in the form of at least one aperture 61 and/or at least one bead 80. Moreover, a side impact inner reinforcement may be added to further strengthen the middle portion 38 of the vehicle pillar assembly 10 in the event of a side impact. Like the side impact reinforcement 40, the inner reinforcement 42 may also include at least one crush initiator 56. The side impact reinforcement 40 and the inner reinforcement 42 may be affixed to one another or may be affixed to the first and second hydroformed support members 14, 16 using a welding method, mechanical fasters or the like.

Referring now to FIGS. 4 and 6, the first hollow support member 14 and the second hollow support member 16 each include a tubular lower area 56 that extends upwardly from the rocker 20. The first hollow support member 14 and the second hollow support member 16 also each include an upper end 26 that extends downwardly from the roof rail 18. As shown in FIG. 4, the first hollow support member 14 and the second hollow support member 16. It is to be understood that the first and second hollow support members 14, 16 may be welded to each other. Non-limiting examples of the attachment between the first and second hollow support members include, but are not limited to: (1) welding and/or mechanical fastening proximate to or at the upper ends 26 of the first and second hollow support members 14, 16; (2) welding and/or mechanical fastening proximate to the tubular lower area 56 of the first and second hollow support members 14, 16; or (3) welding and/or mechanical fastening along the length of the first and second hollow support members 14, 16.

Referring to the side impact reinforcements 40 shown in FIGS. 1, 2 and 4A, it is to be understood that in one non-limiting example, the side impact reinforcement 40 may be formed from HSLA350 Steel where the thickness can be in the range of 0.5 to 1.0 mm. In yet another non-limiting example, the B-Pillar outer bracket 24 shown in FIG. 1 and FIG. 4A may also be formed from DP780 steel. The thickness of the B-Pillar outer bracket 24 may range from 1.0 mm to 2.0 mm. Furthermore the rocker reinforcement 24 shown in FIG. 7 may also, but not necessarily be formed from DP780 Steel.

While the best mode for carrying out the invention has been described in detail, those familiar with the art to which this invention relates will recognize various alternative designs and embodiments for practicing the invention as defined by the following claims.

What is claimed is:

1. A vehicle pillar assembly comprising:
a roof rail;
a rocker;
a first hollow support member and a second hollow support member each having at least a first wall, a second wall and a third wall, the first support member and the second hollow support member each having a tubular lower area with a crush initiator and an upper section, the tubular lower area extends upwardly from the rocker panel and the upper section extends downwardly from the roof rail.

2. The vehicle pillar assembly as defined in claim 1 wherein the crush initiator is operatively configured to provide a low buckle point.

3. The vehicle pillar assembly as defined in claim 1 wherein the crush initiator is an aperture defined in the tubular lower area.

4. The vehicle pillar assembly as defined in claim 1 further comprising a pillar reinforcement.

5. The vehicle pillar assembly as defined in claim 4 wherein the pillar reinforcement defines a reinforcement crush initiator.

6. The vehicle pillar assembly as defined in claim 1 wherein the crush initiator is a bead.

7. The vehicle pillar assembly as defined in claim 6 wherein the reinforcement crush initiator is at least one aperture.

8. The vehicle pillar assembly as defined in claim 1 wherein the first and second hollow support members each having an upper end, the upper end of each of the first hollow support member and the second hollow support member is compressed together to form a rail attachment flange, the rail attachment flange being assembled to the roof rail.

9. The vehicle pillar assembly as defined in claim 1 wherein each tubular upper section of the first and second hollow support members are coupled to the roof rail via a b-pillar bracket.

10. The vehicle pillar assembly as defined in claim 1 wherein the compressed upper ends of the first hollow support member and the second hollow support member define a rail attachment flange that is assembled to the roof rail.

11. The vehicle pillar assembly of claim 10 wherein the rail attachment flange is spot welded to the roof rail.

12. The vehicle pillar assembly of claim 1 further comprising a side reinforcement bracket affixed to the first hollow support member and the second hollow support member.

13. The vehicle pillar assembly of claim 1 further comprising a rocker reinforcement operatively configured to couple the first hollow support member and the second hollow support member to the rocker.

14. The vehicle pillar assembly of claim 1 wherein the first and second hollow support members are welded to one another at the upper section of each the first and second hollow support members.
